(19) United States
(12) Patent Application Publication
(10) Pub. No.: US 2024/0351235 A1
(43) Pub. Date: Oct. 24, 2024

(54) TOOL REST POSITIONING DEVICE FOR WOOD LATHE

(71) Applicant: THE KINGCRAFT MACHINERY COMPANY LIMITED, Taichung City (TW)

(72) Inventors: CALVIN CHOU, Taichung City (TW); MING-TA CHOU, Taichung City (TW)

(21) Appl. No.: 18/136,898

(22) Filed: Apr. 20, 2023

(51) Int. Cl. B27C 7/06; B23Q 1/44

(52) U.S. Cl. CPC B27C 7/06; B23Q 1/44

(57) ABSTRACT

A tool rest positioning device for wood lathe includes a base, an operation rod, a positioning device, and a holding member. The operation rod passes through the base and rotates between a locked position and an unlocked position. The positioning device includes an eccentric member, a pulling member, and an abutting assembly. The operation rod passes through the eccentric member. The pulling member is pivotally disposed on the outer periphery of the eccentric member. The abutting assembly is disposed on one end of the pulling member away from the eccentric member. At the locked position, the eccentric member drives the pulling member to pull the abutting assembly to abut against the slide rail of the lathe. The holding member is disposed in the base, preventing the operation rod from moving away from a containing groove at the locked position to be deformed.

### BACKGROUND OF THE INVENTION

### 1. Field of the Invention

The present invention relates to tool rests, and more particularly, to a tool rest positioning device for wood lathe.

### 2. Description of the Related Art

As shown by FIG. 1, a conventional wood lathe structure is disclosed, wherein the tool rack 100 is arranged on the slide rail 201 of the wood lathe 200. The tool rack 100 is able to slide forward and backward along the direction of the slide rail 201. Therein, the tool rack 100 comprises a tool seat 101, which comprises an operation rod 102 rotatably arranged along the length direction of the tool seat 101. The operation rod 102 comprises an eccentric part 103, on which a pulling member 104 is mounted near the center thereof, wherein a washer 105 and a nut 106 are fastened on the lower end of the pulling member 104 passing through the slide rail 201. With such configuration, the user rotates the operation rod 102, such that the rotation rod 102 drives the pulling member 104 to move upward or downward through the eccentric part 103, so as to control the washer 105 to be abutting against the slide rail 201 or not, thereby selectively positioning the tool rack 100 at a position on the slide rail 201.

However, at the locked position, the operation rod 102 bears the pulling force of the pulling member 104 downward. After a long period of usage, the force-bearing portion of the operation rod 102 is easily deformed to be bent. As a result, after the operation rod 102 rotates back to the non-locked position, due to the bending of the operation rod 102, when the operation rod 102 is locked again, the abutting force of the pulling member 104 is reduced, failing to stably position the tool rack 100 on the slide rail 201 and achieve a stable locking effect.

### SUMMARY OF THE INVENTION

To improve the issues above, the present invention discloses a tool rest positioning device for tool lathe, which applies a holding member to receive an operation rod, so as to prevent the operation rod from deformation due to force-bearing at the locked position.

For achieving the aforementioned objectives, a tool rest positioning device for wood lathe is provided, comprising a base, an operation rod, a positioning device, and a holding member. The base comprises a containing groove disposed along the length direction. The operation rod passes through the containing groove along a rotation axis and rotates between a locked position and an unlocked position with respect to the base. The positioning device comprises an eccentric member, a pulling member, and an abutting assembly. The eccentric member comprises an eccentric bore passing therethrough, and the operation rod passes through the eccentric bore. The pulling member is pivotally disposed on the outer periphery of the eccentric member. The abutting assembly is disposed on one end of the pulling member away from the eccentric member. At the locked position, the eccentric member is applied to drive the pulling member to pull the abutting assembly in a direction perpendicular to the rotation axis to abut against the slide rail of the lathe. The holding member is slidably disposed in the containing groove and arranged in the moving path of the pulling member. Therefore, at the locked position, the holding member prevents the operation rod from moving away from the containing groove.

With such configuration, the present invention uses the holding member disposed between the base and the operation rod to receive the operation rod. At the locked position, the force-bearing operation rod is prevented from deformation. Therefore, when the base is positioned on any position on the slide rail, the pressing force of the positioning device pressing the slide rail does not change due to the deformation of the operation rod, preventing the failure of locking.

### BRIEF DESCRIPTION OF THE DRAWINGS

FIG. 1 is a sectional view of a conventional wood lathe structure, illustrating the tool rack being positioned on the slide rail of the wood lathe.

FIG. 2 is an exploded view of the tool rest positioning device in accordance with an embodiment of the present invention.

FIG. 3 is a sectional view of the tool rest positioning device in accordance with an embodiment of the present invention, illustrating the abutting member abutting against the slide rail at the locked position.

FIG. 4 is a cross-sectional view taken along line 4-4 in FIG. 3.

FIG. 5 is a cross-sectional view taken along line 5-5 in FIG. 3.

FIG. 6 is a sectional view of the tool rest positioning device in accordance with an embodiment of the present invention, illustrating the abutting member not abutting against the slide rail at the unlocked position.

FIG. 7 is a cross-sectional view taken along line 7-7 in FIG. 6.

### DETAILED DESCRIPTION OF THE INVENTION

The aforementioned and further advantages and features of the present invention will be understood by reference to the description of the preferred embodiment in conjunction with the accompanying drawings where the components are illustrated based on a proportion for explanation but not subject to the actual component proportion.

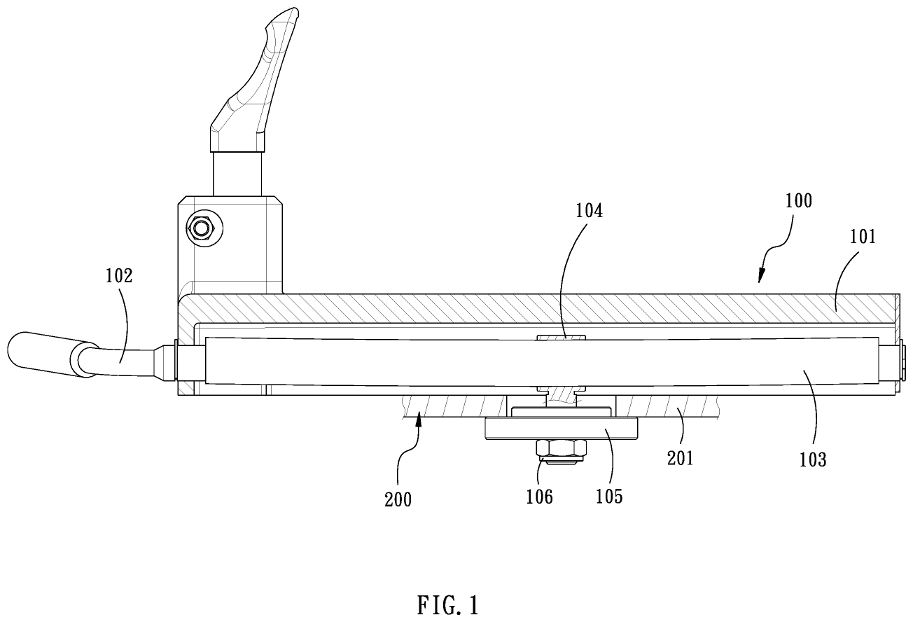

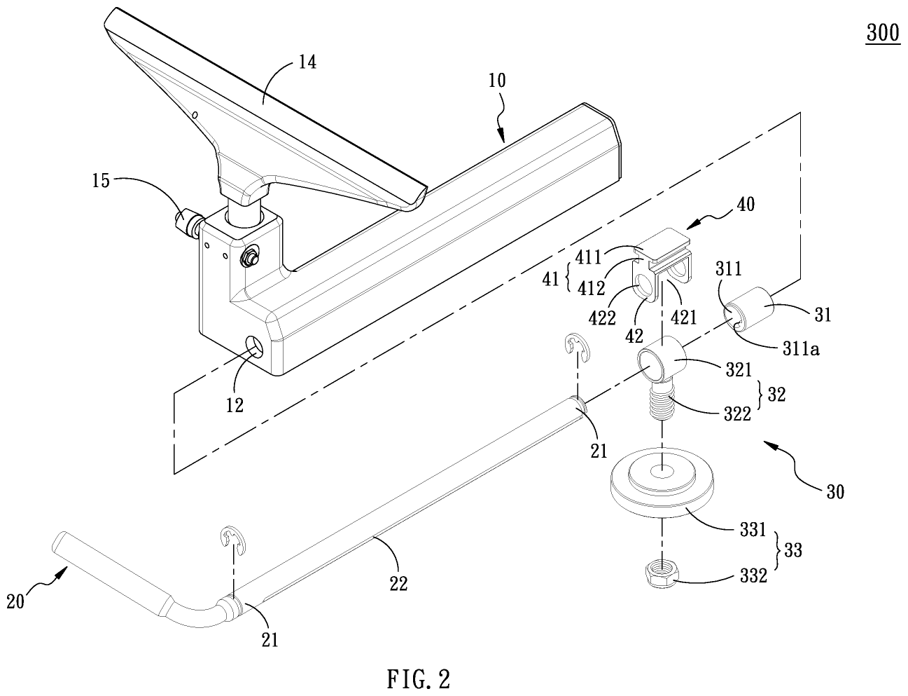

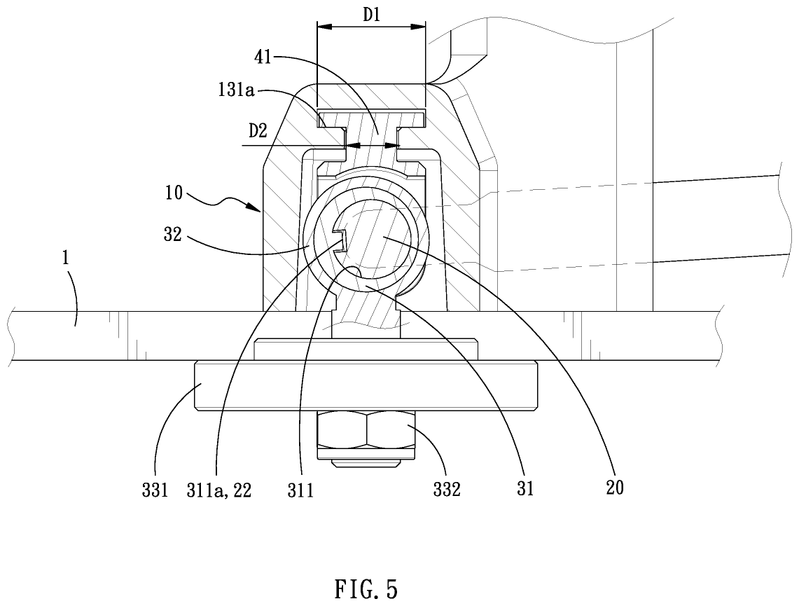

Referring to FIG. 1 to FIG. 7, the present invention disposes a tool rest positioning device 300 for wood lathe, which is slidably disposed on a slide rail 1 of a wood lathe to be selectively positioned at one position on the slide rail 1. The tool rest positioning device 300 comprises a base 10, an operation rod 20, a positioning device 30, and a holding member 40.

The base 10 is formed in an elongate shape. The base 10 comprises a containing groove 11 arranged along the length direction on the bottom of the base 10. The base 10 comprises an axle bore 12 formed on two opposite sides thereof, respectively, and the two axle bores 12 are in communication with the containing groove 11. The containing groove 11 concavely comprises a slide groove 13 on the inner side thereof. In the embodiment, the slide groove 13 has a T-shaped sectional face and comprises an inner groove 131 and an outer groove 132 in communication with each other. The inner groove 131 has a first width D1, and the outer groove 132 has a second width D2, wherein the first width D1 is larger than the second width D2. Also, the inner groove 131 comprises a stop face 131a on two sides of the outer groove 132, respectively. Therein, the base 10 comprises a tool guide plate 14 and a control member 15 on one side thereof. With the control member 15, the height of the tool guide plate 14 is allowed to be adjusted with respect to the base 10, such that the to-be-processed wood abuts against the tool guide plate 14 for the turning operation. The tool guide plate 14 and the control member 15 are not the technical focus of the present invention, therefore relative contents are omitted here.

The operation rod 20 passes through the containing groove 11 along a rotation axis X and rotates between a locked position and an unlocked position with respect to the base 10. The slide groove 13 is arranged in parallel to the rotation axis X. Further, the operation rod 20 comprises two rotation axle parts 21 disposed in opposite to each other, wherein the two rotation axle parts 21 are rotatably disposed in the two axle bores 12, respectively. Also, the operation rod 20 comprises a first engagement part 22 arranged along an axis direction thereof, and the first engagement part 22 is a recess.

The positioning device 30 comprises an eccentric member 31, a pulling member 32, and an abutting assembly 33. The eccentric member 31 comprises an eccentric bore 311 passing thereof. The bore center of the eccentric member 311 is not concentric with the central axis of the eccentric member 31 itself, so that the eccentric bore 311 is eccentrically arranged on the eccentric member 31. The operation rod 20 passes through the eccentric bore 311 of the eccentric member 31, such that the eccentric member 31 is disposed in positional alignment with a long groove 1a of the slide rail 1. Therein, the eccentric bore 311 comprises a second engagement part 311a on the inner side thereof, and the second engagement part 311a is a protrusion corresponding to the first engagement part 22 of the operation rod 20, such that the eccentric member 31 is prevented from rotating with respect to the operation rod 20.

The pulling member 32 comprises a column part 321 and a thread part 322 extending from the column part 321. The column part 321 is disposed on the outer periphery of the eccentric member 31, and the thread part 322 passes through the long groove 1a of the slide rail 1.

The abutting assembly 33 is installed on one end of the pulling member 32 away from the eccentric member 31. At the locked position, the eccentric member 31 is applied for driving the pulling member 32 to pull the abutting assembly 33 in a direction perpendicular to the rotation axis X to abut against the slide rail 1 of the lathe. In the embodiment, the abutting assembly 33 comprises an abutting member 331 and a screw member 332. The abutting member 331 is allowed to be a washer, and the screw member 332 is allowed to be a nut. The thread part 322 passes through the abutting member 331 to be screwed to the screw member 332. Therefore, when the user drives the operation rod 20 to rotate about the rotation axis X, the operation rod 20 drives the eccentric member 31 to move, such that the eccentric member 31 drives the pulling member 32 to move in the direction perpendicular to the rotation axis X (upward or downward). When the operation rod 20 is at the locked position, the pulling member 32 moves upward, and that the abutting member 331 abuts against the slide rail 1, so that the base 10 and the abutting member 331 clamp the slide rail 1, whereby the base 10 is positioned on the slide rail 1. Similarly, when the operation rod 20 is at the unlocked position, the pulling member 32 moves downward, and the abutting member 331 is relaxed and not abutting against the slide rail 1, whereby the base 10 is able to adjustably slide on the slide rail 1.

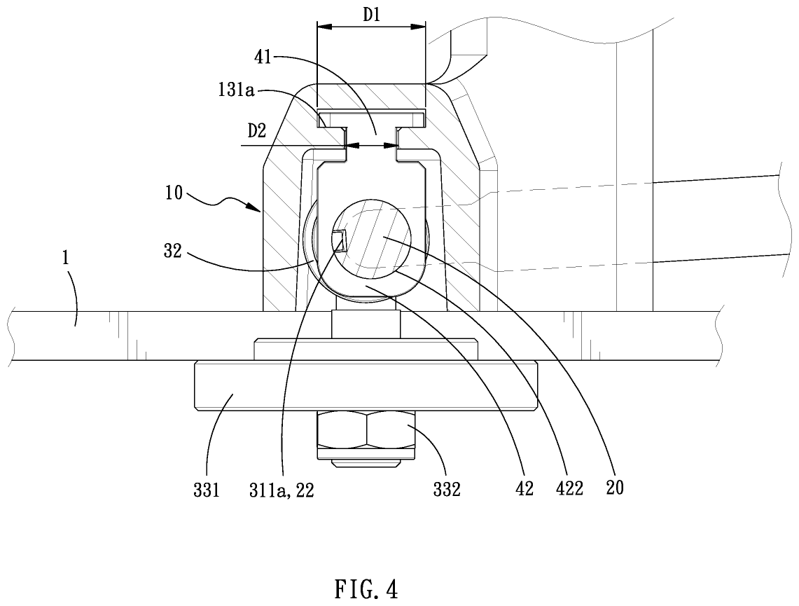

The holding member 40 is disposed between the base 10 and the operation rod 20. The holding member 40 comprises an installation part 41 and a holding arm 42 perpendicularly extending from the installation part 41 on one end of the holding member 40. The installation part 41 is slidably disposed in the slide groove 13 of the containing groove 11, and arranged on the moving path of the pulling member 32. The holding arm 42 is applied to receive the operation rod 20, so as to prevent the operation rod 20 from moving away from the containing groove 11 at the locked position. Referring to FIG. 4, in the embodiment, the installation part 41 has a sectional face matching the slide groove 13; in other words, the installation part 41 is formed in a T shape as well. The installation part 41 comprises a stop block 411 corresponding to the inner groove 131 and a neck segment 412 corresponding to the outer groove 132 and connected with the stop block 411. The stop block 411 abuts against the stop face 131a, and the holding member 40 is suspended in the base 10, with the holding arm 42 receiving the operation rod 20.

In the embodiment, two holding arms 42 are included and perpendicularly extending from two sides of the installation part 41, with a space 421 formed between the two holding arms 42 for receiving the pulling member 32. Also, each of the two holding arms 42 comprises a holding bore 422, which is shaped corresponding to the sectional shape of the operation rod 20, allowing the operation rod 20 to pass therethrough.

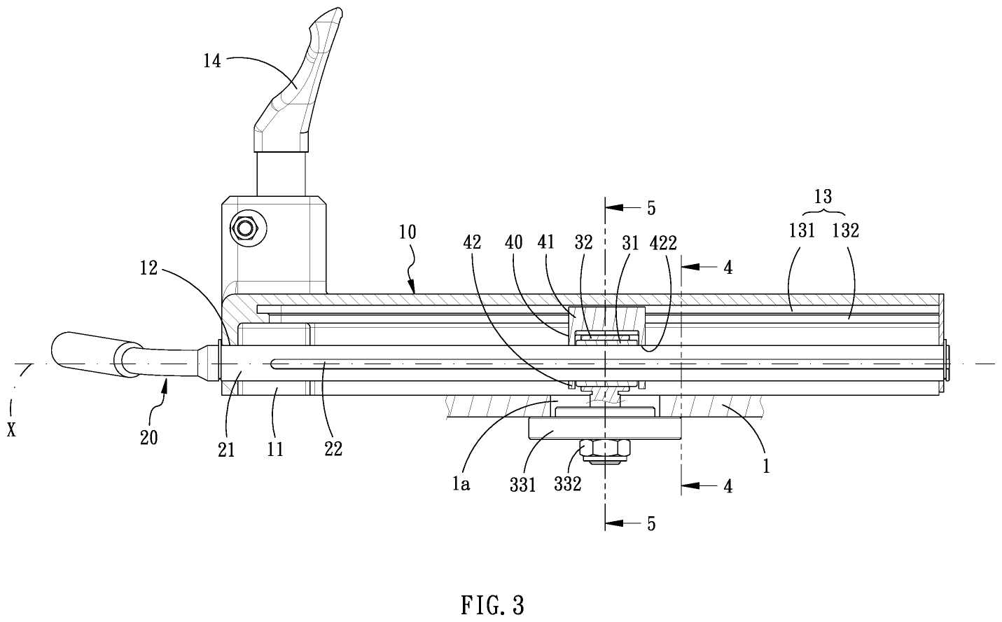

Referring to FIG. 3 to FIG. 5, the operation rod 20 is at the locked position. According to a force transmission effect, the operation rod 20 bears a downward pulling force. With the holding member 40 of the present invention disposed between the base 10 and the operation rod 20, the holding member 40 receives the operation rod 20 through the holding arms 42. The holding member 40 is disposed in position alignment with the pulling member 32, so that the holding arms 42 provide a support function to the operation rod 20, such that the operation rod 20 is prevented from moving away from the containing groove 11, so as to prevent the deformation of the operation rod 20 and the failure of subsequent locking operations.

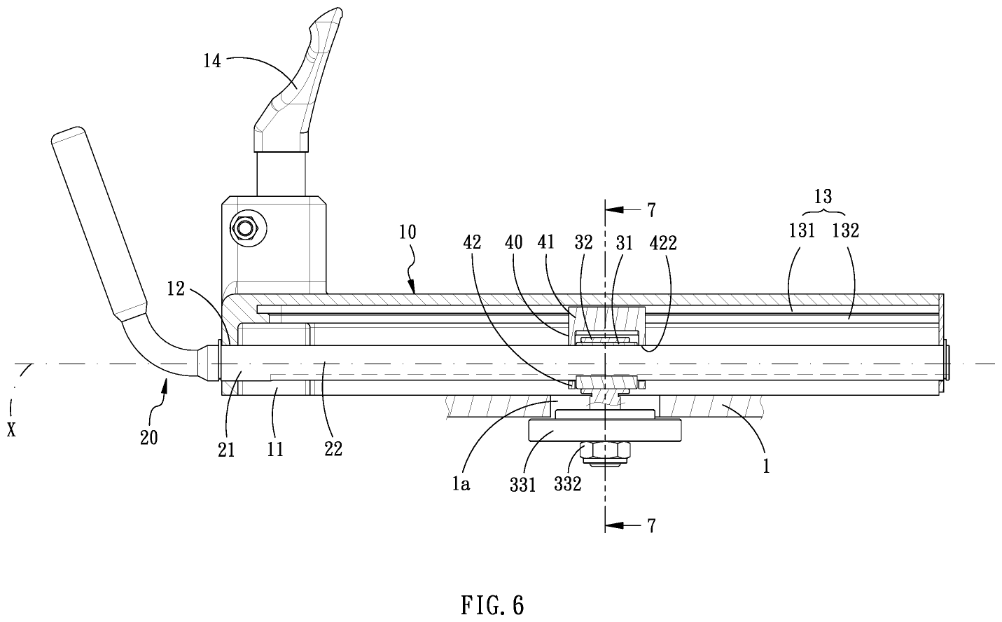

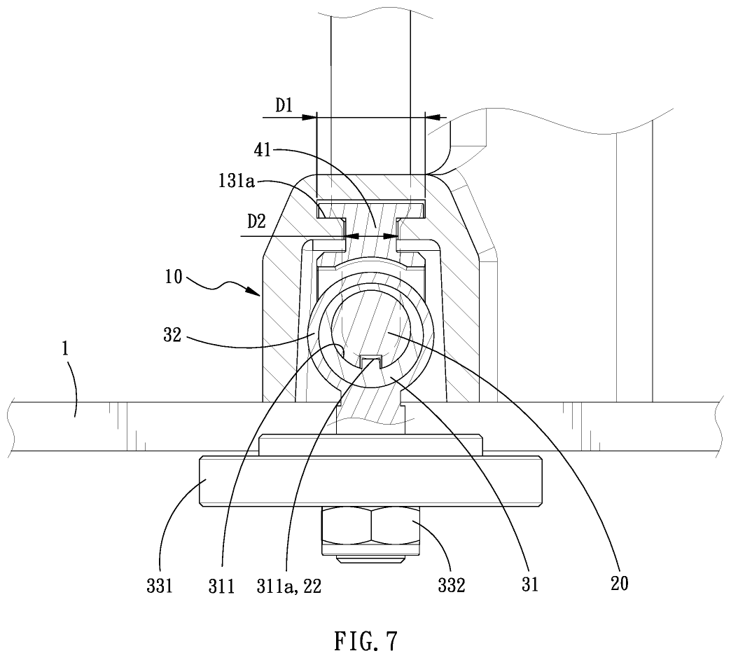

Referring to FIG. 6 and FIG. 7, the operation rod 20 is at the unlocked position. According to the aforementioned contents, when the user rotates the operation rod 20, the operation rod 20 drives the eccentric member 31 to rotate to the position shown in FIG. 7 for driving the pulling member 32 to move downward in the space 421, such that the abutting member 331 is relaxed and does not abut against the slide rail 1 at the unlocked position, thereby allowing the base 10 to adjustably slide on the slide rail 1.

Although particular embodiments of the present invention have been described in detail for purposes of illustration, various modifications and enhancements may be made without departing from the spirit and scope of the invention. Accordingly, the invention is not to be limited except as by the appended claims.

What is claimed is:

1. A tool rest positioning device for wood lathe, comprising:
a base comprising a containing groove along a length direction on a bottom of the base;
an operation rod passing through the containing groove along a rotation axis and rotating between a locked position and an unlocked position;
a positioning device comprising an eccentric member, a pulling member, and an abutting assembly, the eccentric member having an eccentric bore passing therethrough to receive the operation rod, the operation rod passing through the eccentric bore, the pulling member pivotally disposed on an outer periphery of the eccentric member, the abutting assembly disposed on one end of the pulling member away from the eccentric member; at the locked position, the eccentric member driving the pulling member to pull the abutting assembly in a direction perpendicular to the rotation axis to abut against a slide rail of a lathe; and
a holding member slidably disposed in the containing groove and arranged on a moving path of the pulling member; at the locked position, the holding member preventing the operation rod from moving away from the containing groove.

2. The tool rest positioning device for wood lathe of claim 1, wherein the containing groove concavely comprises a slide groove on an inner side of the containing groove; the holding member comprises an installation part and a holding arm perpendicularly extending from the installation part on one end of the holding member; the installation part is slidably disposed in the slide groove; the holding arm receives the operation rod.

3. The tool rest positioning device for wood lathe of claim 2, wherein the slide groove comprises an inner groove and an outer groove in communication with each other; the inner groove has a first width, and the outer groove has a second width, wherein the first width is larger than the second width; the installation part comprises a stop block corresponding to the inner groove and a neck segment corresponding to the outer groove and connected with the stop block.

4. The tool rest positioning device for wood lathe of claim 3, wherein the inner groove comprises a stop face on two sides of the outer groove, respectively, and the stop block abuts against the stop faces.

5. The tool rest positioning device for wood lathe of claim 2, wherein the slide groove has a T-shaped sectional face; the installation part has a sectional face matching the slide groove.

6. The tool rest positioning device for wood lathe of claim 2, wherein two holding arms are included and extend from two sides of the installation part, with a space formed between the two holding arms to receive the pulling member; each of the two holding arms comprises a holding bore, through which the operation rod passes.

7. The tool rest positioning device for wood lathe of claim 1, wherein the operation rod comprises a first engagement part arranged along an axis direction of the operation rod, and the eccentric bore comprises a second engagement part on an inner side of the eccentric bore, wherein the second engagement part and the first engagement part are engaged, such that the eccentric member is prevented from rotating with respect to the operation rod.

8. The tool rest positioning device for wood lathe of claim 7, wherein the first engagement part is a protrusion, and the second engagement part is a recess.

9. The tool rest positioning device for wood lathe of claim 2, wherein the pulling member comprises a column part pivotally disposed on an outer periphery of the eccentric member, and a thread part extending from the column part; the abutting assembly comprises an abutting member and a screw member, and the thread part passes through the abutting member to be screwed to the screw member.

10. The tool rest positioning device for wood lathe of claim 9, wherein the base comprises an axle bore formed on two opposite sides thereof, respectively, and the two axle bores are in communication with the containing groove; the operation rod comprises two rotation axle parts disposed in opposite to each other, and the two rotation axle parts are rotatably disposed in the two axle bores, respectively.
